(19) United States
(12) Patent Application Publication
(10) Pub. No.: US 2019/0171772 A1
(43) Pub. Date: Jun. 6, 2019

(54) SYSTEM AND METHOD OF SUPPORTING NON-EVENT RELATED INFORMATION IN A CO-BROWSING SESSION

(71) Applicant: Avaya Inc., Santa Clara, CA (US)

(72) Inventors: Avinash Anand, Pune (IN); Divakar Ray, Pune (IN); Anjum Siddique, Pune (IN)

(21) Appl. No.: 15/830,744

(22) Filed: Dec. 4, 2017

(51) Int. Cl. G06F 17/30; G06F 8/40

(52) U.S. Cl. CPC G06F 17/30905; G06F 17/30873; H04L 67/02; G06F 8/40; G06F 17/3089

(57) ABSTRACT

A communication endpoint determines that a co-browsing session has been established between a first browser on the communication endpoint and a co-browsing server. The first browser initiates a listener to identify a user interface event in a browsing session of a web page. The first browser identifies a code element (e.g., a CSS class) associated with the user interface event. The code element modifies a view of the web page, but the modification of the view of the web page is not identified by the user interface event. The first browser converts the code element into a different programming language and sends the converted code element and an identifier of the user interface event to the co-browsing server. The co-browsing server sends the identifier of the event and the converted code element to a second browser to recreate the user interface displayed in the first browser.

### FIELD

The disclosure relates generally relate to web based systems and in particular to co-browsing web systems.

### BACKGROUND

Web collaboration solutions, which are based on the Document Object Model (DOM), exchange information between two parties relying on Java Script to identify changes in the DOM in a co-browsing session. When a web page contains Cascading Style Sheet (CSS) classes/pseudo elements, such as “visited,” “hover,” “active,” “first child,” etc., the browser runs rules associated the CSS classes/pseudo elements without generating any changes in the DOM or event generation. This causes problems in a web co-browsing environment because the CSS classes/pseudo elements can change the display of graphical elements that that are not captured by the DOM or event generation in the browser. In other words, the graphical changes made by the CSS classes/pseudo elements cannot be detected and sent to a remote browser in the co-browsing session. This results in an inaccurate representation of a first browser session being sent to a second browser in the co-browsing session.

### SUMMARY

These and other needs are addressed by the various embodiments and configurations of the present disclosure. A communication endpoint determines that a co-browsing session has been established between a first browser on the communication endpoint and a co-browsing server. The first browser initiates a listener to identify a user interface event in a browsing session of a web page. The first browser identifies a code element (e.g., a CSS class) associated with the user interface event. The code element modifies a view of the web page, but the modification of the view of the web page is not identified by the user interface event. The first browser converts the code element into a different programming language and sends the converted code element and an identifier of the user interface event to the co-browsing server. The co-browsing server sends the identifier of the event and the converted code element to a second browser to recreate the user interface displayed in the first browser.

The present disclosure can provide a number of advantages depending on the particular configuration.

These and other advantages will be apparent from the disclosure contained herein.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for managing a co-browsing session.

FIG. 2 is a block diagram of a browser that is used in a co-browsing session.

FIG. 3 is a flow diagram of a process of a browser handling a co-browsing session.

FIG. 4 is a flow diagram of a process of a co-browsing server handling a co-browsing session.

FIG. 5 is a flow diagram of a process of a browser handling a co-browsing session.

### DETAILED DESCRIPTION

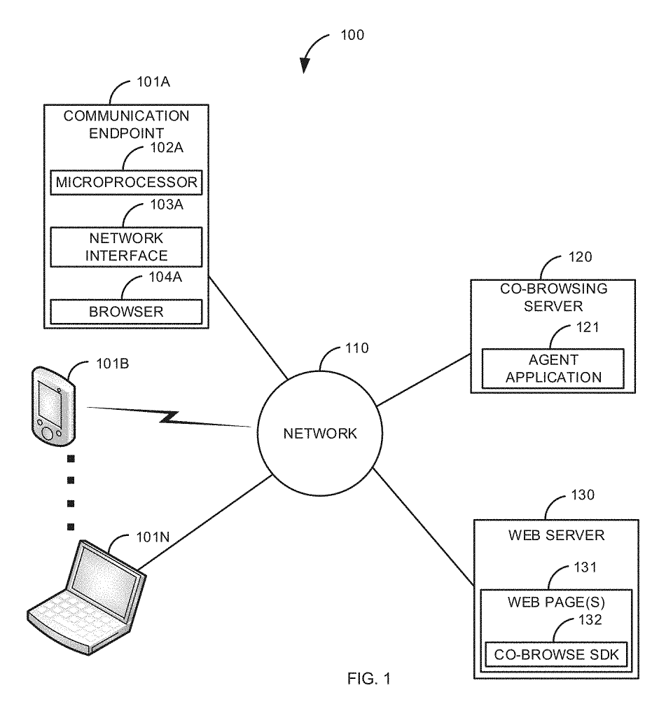

FIG. 1 is a block diagram of a first illustrative system 100 for managing a co-browsing session. The first illustrative system 100 comprises communication endpoints 101A-101N, a network 110, a co-browsing server 120, and a web server 130.

The communication endpoints 101A-101N can be or may include any communication endpoint device that can communicate on the network 110, such as a Personal Computer (PC), a telephone, video phone, a cellular telephone, a Personal Digital Assistant (PDA), a tablet device, a notebook device, a smartphone, and the like. The communication endpoints 101A-101N are devices where a communication sessions ends. The communication endpoints 101A-101N are not network elements that facilitate and/or relay a communication session in the network, such as a communication manager or router. As shown in FIG. 1, any number of communication endpoints 101A-101N may be connected to the network 110.

The communication endpoint 101A comprises a microprocessor 102A, a network interface 103A, and a browser 104A. The microprocessor 102A can be or may include any hardware processor, such as a Digital Signaling Processor (DSP), an application specific processor, a microcontroller, a multi-core processor, and/or the like.

The network interface 103A can be or may include any hardware interface coupled with software that can communicate with the network 110. For example, the network interface 103A can be a wireless interface, a wired interface, a fiber optic interface, an Ethernet interface, a cellular interface, a WiFi interface, and/or the like.

The browser 104A can be or may include any browser that can communicate with a web server 130, such as Google Chrome®, Microsoft Internet Explorer®, Safari®, Firefox®, Opera®, and/or the like. The browser 104A may be downloaded or pre-installed on the communication endpoint 101A.

In FIG. 1, the communication endpoints 101B-101N are not shown with a microprocessor 102, a network interface 103, or a browser 104 for simplicity. However, for illustrative examples discussed herein, the communication endpoints 101B-101N also comprise corresponding microprocessors 102B-102N, network interfaces 103B-103N, and browsers 104B-104N.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), Hyper Text Markup Language (HTML), Java Script, Web Real-Time Communication (WebRTC), and/or the like. Thus, the network 110 is an electronic communication network configured to carry messages via packets and/or circuit switched communications.

The co-browsing server 120 can be or may include any server that can facilitate a co-browsing session between two or more communication endpoints 101A-101N to view web pages 131 provided by the web server 130. The co-browsing server 120 may be located in various places in the network 110, such as in an enterprise (e.g., a corporate server), as a cloud service, and/or the like. The co-browsing server 120 may support a plurality of co-browsing sessions from an individual web server 130. The co-browsing server 120 may support co-browsing sessions that involve a multiple different web servers 130. In one embodiment, the co-browsing server 120 can be in a communication endpoint 101.

The co-browsing server 120 may also comprise an agent application 121. The agent application 121 is used by a contact center agent to generate a unique code/key that the contact center agent can send to a user of the browser 104 to establish a co-browsing session between the user at the communication endpoint 101A to the agent at another communication endpoint (e.g., communication endpoint 101N).

The web server 130 can be or may include any software/hardware that can work with the browser 104 to provide one or more web pages 131, such as Apache®, Nginx®, Microsoft-ITS®, Tomcat®, and/or the like. The web server 130 may comprise a plurality of web servers 130. For example, the web server 130 may comprise different web servers 130 from different companies, enterprises, groups, and/or the like. The web server 130 provides web page(s) 131 that can be viewed by a user running a browser 104 on a communication endpoint 101.

The web page(s) 131 further comprise a co-browse Software Development Kit (SDK) 132. The co-browse SDK 132 provides a group of Application Programming Interfaces (APIs) that are used to establish a co-browsing session with the co-browsing server 120. For example, a user may enter a code/key, provided by a contact center agent, into a web page 131 displayed in the browser 104 to establish a co-browsing session. The entered code/key is used by the co-browse SDK 132 to establish the co-browsing session with the co-browsing server 120. The co-browse SDK 132 provides a mechanism to send code/converted code to the co-browsing server 120 that allows the contact center agent to see the same or a similar view as the user is seeing in the browser 104A.

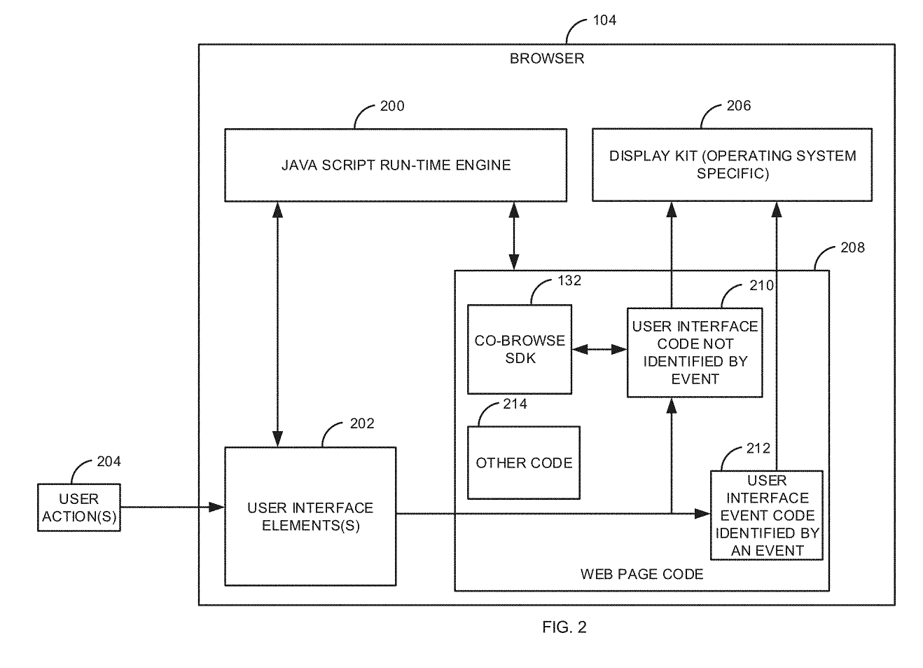

FIG. 2 is a block diagram of a browser 104 that is used in a co-browsing session. The browser 104 is depicted where a web page 131 has been uploaded from the web server 130. The browser 104 comprises a java script run-time engine 200, user interface element(s) 202, a display kit 206, and web page code 208.

The java script run-time engine 200 is a software interpreter that interprets java script/HTML of a web page 131 for view by a user in the browser 104. The java script run-time engine 200 can be or may include well-known java script run-time engines 100 that are included into today's browsers 104.

The user interface elements 202 can be or may include any user interface elements 202 that can be displayed/sounded by a browser 104, such as a button, a window, a pane, panel, a menu, a menu item, an icon, a tab, a text object, a text entry object, a scroll bar, a slider, a cursor, a picture, a video, a sound object, a vibration object, and/or the like.

The display kit 206 can be or may include any hardware/software that can be used to display the user interface elements 202 for the particular communication endpoint 101. The display kit 206 is an interface between the hardware display and the specific operating system (e.g. Linux®, Windows®, iOS®, Mac OS®, etc.) being used in the communication endpoint 101.

The web page code 208 is code that is uploaded to the browser 104 when a user accesses a web page 131. For example, when the user enters a Uniform Resource Locator (URL) in the browser 104, the code from the web page 131 associated with the URL is uploaded to the browser 104. The java script run-time engine 200 interprets the uploaded web page code 208 for display to the user.

The web page code 208 comprises the co-browse SDK 132, user interface code that is associated with an event, but not identified by the event 210, user interface code identified by an event 212, and other code 214. The co-browse SDK 132 may be the same or comprise sub-elements of the co-browse SDK 132 on the web server 130. The co-browse SDK 132 is used by the browser 104 to communicate with the co-browsing server 120.

The user interface code identified by an event 212 and the user interface code associated with the event, but not identified by an event 210 are different code elements (pieces of code, function calls, etc.) that modify a view of a web page 131 when the event occurs. An event is an action associated with specific user interface element 202. An event may occur based on a user action 204. For example, the user action 204 may be when a user clicks on button, when a cursor hovers over a text field, when the user touches a user interface element 202 in a touch screen, when the user enter text in a text field, when the user selects a menu, when the user selects a text box, when the user selects a tab, and/or the like.

The Java script run-time engine 200 can be programmed, by the web page code 208 (i.e., the co-browse SDK 132), to listen for specific event(s) associated with a specific user interface element 202. For example, an event may be when a user clicks on a specific button displayed to the user in the browser 104. In one embodiment, all events associated with all the user interface elements 202 may be listened for by the co-browse SDK 132.

The user interface code not identified by an event 210 are pieces of code that modify the view of what the user sees in the browser 104. However, the user interface code not identified by the event 210 makes changes to the display, but the changes are not indicated by the Java script run-time engine 200 (the DOM) when the event occurs. For example, the event may be when a cursor hovers over a text field. The hover event is reported, but in this case, what occurs after the hover event is not reported by the java script run-time engine 200 to the co-browse SDK 132. For example, the event may report the hover event, but a window that is displayed based on the hover event in a particular color and font size of text is not changed in code called by the event.

The user interface code not identified by the event 210 can occur in different types of code in the web page 131. For example, a Cascading Style Sheet (CSS) pseudo-element and CSS classes can be used to style specified parts of a user interface element 202, insert content before or after the content of a user interface element 202, and/or the like. The use of CSS pseudo-elements and CSS classes change the view in the browser 104, but the reported event does not contain the changes made by the CSS pseudo-elements/CSS classes.

Shown below are some examples of pseudo classes for the events hover, focus, and visited.

a:hover {

background-color: yellow;

}
input:focus {

background-color: yellow;

}
a:visited {

color: pink;

}

An illustrative example, of a CSS pseudo element is shown below:

selector::pseudo-element {

property:value;

}

In CSS 3 the double colon was replaced for a single-colon notation for pseudo-elements. This was an attempt from the World Wide Web Consortium (WC3) to distinguish between pseudo-classes and pseudo elements. In CSS 3, pseudo elements have a double colon :: in the notation and pseudo classes have a single colon : in the syntax.

In addition, CSS pseudo-elements and CSS classes may be combined. For example as shown below a CSS pseudo-element is combined with a CSS class.

p.intro::first-letter {

color: #ff0000;
font-size:200%;

}

In addition, HTML code may also modify a view seen by the user, but not receive any event notification when changes are made to what the user actually sees. For example, when a cursor hovers over a user interface element 202 and a title is displayed that says “I would like to receive email about a promotional updates and current offers from Avaya” as shown below, there is no actual notification of the title being displayed by the java script run-time engine 200/DOM.

Below is an exemplary code snippet that achieves the above displayed title.

<label for=“pers_email_info”>Send me promotional e-mails

<a target=“” title=“I would like to receive emails about promotional

updates and current offers from Avaya”>Learn More</a>
</label>

When the user hovers the cursor on the link (“Learn More”), the title appears like above but no change in Document Object Management (DOM) (in the java script run-time engine 200 is reported).

Another example of HTML code is where select dropdowns are in their open state. For example, as the HTML code below illustrates.

<select>

<option value=“volvo”>Volvo</option>
<option value=“saab”>Saab</option>
<option value=“mercedes”>Mercedes</option>
<option value=“audi”>Audi</option>

</select>

The above example is rendered as shown below:

Volvo ∇

However, when the user clicks on the dropdown and the display changes like shown below, no change to the DOM (in the java script run-time engine 200) is reported when the display changes as shown below.

Volvo ∇
Volvo
Saab
Opel
Audi

The user interface code identified by the event 212 is code that is identified by the java script run-time engine 200 when the event occurs. The other code 214 can be or may include code that is not used in the graphical user interface.

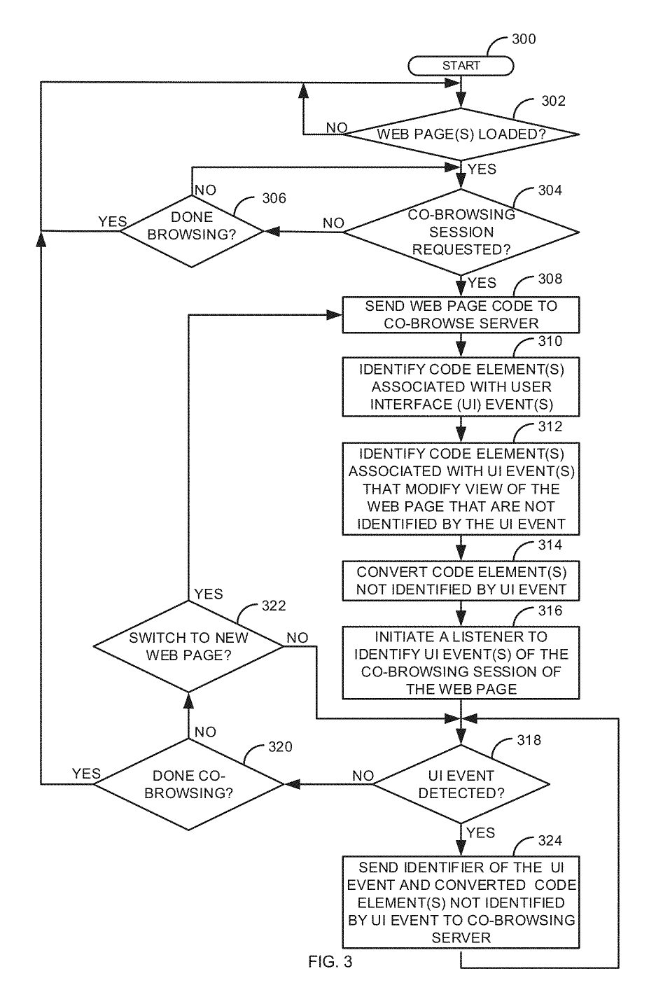

FIG. 3 is a flow diagram of a process of a browser 104 handling a co-browsing session. Illustratively, browser 104, the co-browsing server 120, the agent application 121, the web server 130, the web pages 131, the co-browse SDK 132, the java script run-time engine 200, the user interface elements 202, the display kit 206, and the web page code 208 are stored-program-controlled entities, such as a computer or microprocessor 102, which performs the method of FIGS. 3-5 and the processes described herein by executing program instructions stored in a computer readable storage medium, such as a memory (i.e., a computer memory, a hard disk, and/or the like). Although the methods described in FIGS. 3-5 are shown in a specific order, one of skill in the art would recognize that the steps in FIGS. 3-5 may be implemented in different orders and/or be implemented in a multi-threaded environment. Moreover, various steps may be omitted or added based on implementation.

The process of FIG. 3 is from perspective of the browser 104A. The process starts in step 300. The browser 104A waits for a web page 131 to load in step 302. If a web page 131 has not been loaded in step 302, the browser 104A waits to load a web page 131 to be loaded in step 302.

If a web page has been loaded in step 302, the browser 104A builds a HTML Document Object Model (DOM) of the web page 131. The HTML DOM of the web page 131 is a tree of objects for the web page 131. The co-browse SDK 132 determines if a co-browsing session has been requested in step 304. If a co-browsing session has not been requested in step 304, the browser 104 determines if the user is done browsing in step 306. For example, the user may have closed the browser 104 or navigated to another web site. If the user is done browsing in step 306, the process goes back to step 302. Otherwise, if the user is not done browsing in step 306, the process goes back to step 304.

The co-browsing session can be requested in various ways in step 304. For example, a user of the communication endpoint 101A may call contact center agent and indicate that the user wants to establish a co-browsing session so that the contact center agent may help the user navigate a web page 131. The contact center agent gives the user a code/key (generated by the agent application 121) that identifies a co-browsing session. The user enters the code/key in the web page 131 (that uses the co-browse SDK 132) to begin the co-browsing session with the contact center agent. Alternatively, the user may initiate a chat session, via the web page 131, to get the code/key to initiate the co-browsing session.

The co-browsing session may be for a single web page 131 or for a group of web pages 131 on the web server 130. Alternatively, the co-browsing session may be for all the web pages 131 hosted on the web server 130.

If a co-browsing session has been requested in step 304, the co-browse SDK 132 sends, in step 308, the web page code 208 to the co-browsing server 120. For example, the co-browse SDK 132 may send the web page code 208 in a base 64 encoded form to the co-browsing server 120.

The co-browse SDK 132 identifies code element(s) associated with user interface event(s) in step 310. There may be a variety of user interface events associated with the web page 131. For example, there may be a user interface event when a user clicks on a button, selects a menu, hovers a cursor over a user interface element 202, right clicks on a mouse, left clicks on the mouse, moves a cursor, clicks on an icon, drags and drops a user interface element 202 selects a scroll bar, and/or the like.

The co-browse SDK 132 identifies code element(s) associated with the user interface events that modify a view of the web page 131 that are not identified by the user interface event in step 312. For example, the identified code element(s) may be one or more of a Cascading Style Sheet (CSS) pseudo-element, CSS pseudo class, a CSS class, a Hyper Text Markup Language (HTML) label element, and a HTML dropdown menu, and/or the like. The co-browse SDK 132 converts, in step 314, converts the code element(s) not identified by the user interface event into a different programming language. For example, the co-browse SDK 132 may convert CSS/HTML code to a java script. In one embodiment, the co-browse SDK 132 converts the code into the different programming language by getting a predefined piece of code (e.g., a predefined function) to replace the identified code element. In another embodiment, the code may be converted into multiple programming languages. For example, the converted code may comprise java script and HTML.

The co-browse SDK 132 initiates a listener, in step 316, with the java script run-time engine 200, to identify user interface event(s) of the co-browsing session of the web page 131 when they occur. In one embodiment, the co-browse SDK 132 initiates a listener for all user interface events of the web page 131.

The java script run-time engine 200 determines, in step 318, if a listened for user interface event has been detected. For example, the user interface event may be where user of the browser 104A has clicked on a button in the web page 131. If a user interface event has not been detected in step 318, the co-browse SDK 132 determines if the user is done co-browsing in step 320. If the user is done co-browsing, in step 320, the process goes back to step 302. Otherwise, if the user is not done co-browsing, in step 320, the process goes to step 322. If the user still is co-browsing, but has switched to a new web page 131 in step 322, the process goes to step 308 where the new web page code 208 is sent to the co-browse server 120. Otherwise, if the user has not switched to a new web page 131, the process goes back to step 318 to see if a new listened for event has been determined.

If a user interface event is detected in step 318, the co-browse SDK 132 sends, in step 324, an identifier of the user interface event (e.g., that the user clicked on a button) and the converted code from step 314 (if there is code not identified by the event) to the co-browsing server 120. The process then goes back to step 318 to determine if another user interface event has been detected.

In one embodiment, instead of sending the converted code element(s) in step 324 when the event occurs, all of the converted code elements (of step 314) may be sent after step 314. In this embodiment, only the event is sent in step 324.

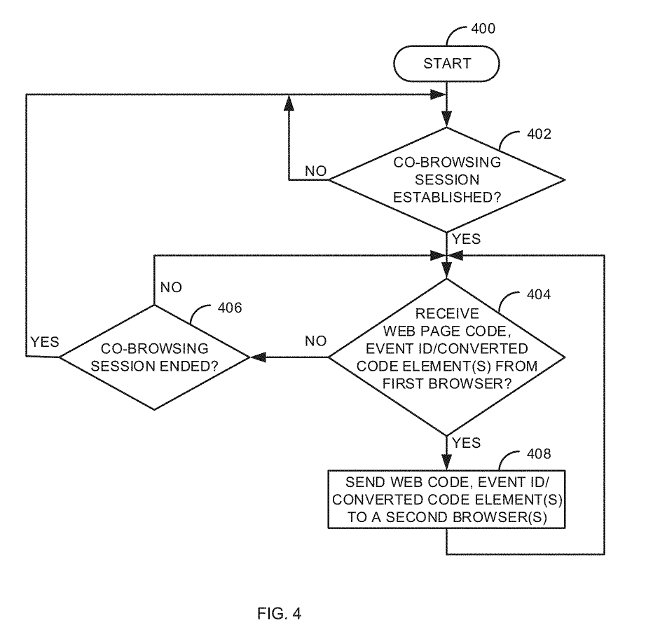

FIG. 4 is a flow diagram of a process of a co-browsing server 120 handling a co-browsing session. The process of FIG. 4 is from the perspective of the co-browsing server 120. The process starts in step 400. The co-browsing server 120 determines in step 402 if a co-browsing session has been established in step 402. If a co-browsing session has not been established in step 402, the process repeats step 402.

Otherwise, if the co-browsing session has been established in step 402, the co-browsing server 120 determines in step 404 if web code (sent in step 308) or event/code elements(s) have been received from the browser 104A (sent in step 324). If web code, an event identifier, and/or converted code element(s) have not been received in step 404, the co-browsing server 120 determines if the co-browsing session has ended in step 406. For example, the user of the browser 104A has closed the browser 104A. If the co-browsing session has ended in step 406, the process goes back to step 402. Otherwise, if the co-browsing session has not ended in step 406, the process goes back to step 404.

If web code, an event identifier, and/or converted code element(s) has been received from the browser 104A in step 404, the co-browsing server 120 sends (forwards) the received web code, the event identifier, and/or the converted code element(s) from step 404 to the browser 104N), in step 408. In one embodiment, where there are more than two browsers 104 involved in the co-browsing session, the information may be sent to one or more other browsers 104 (e.g., browser 104B). The process then goes back to step 404.

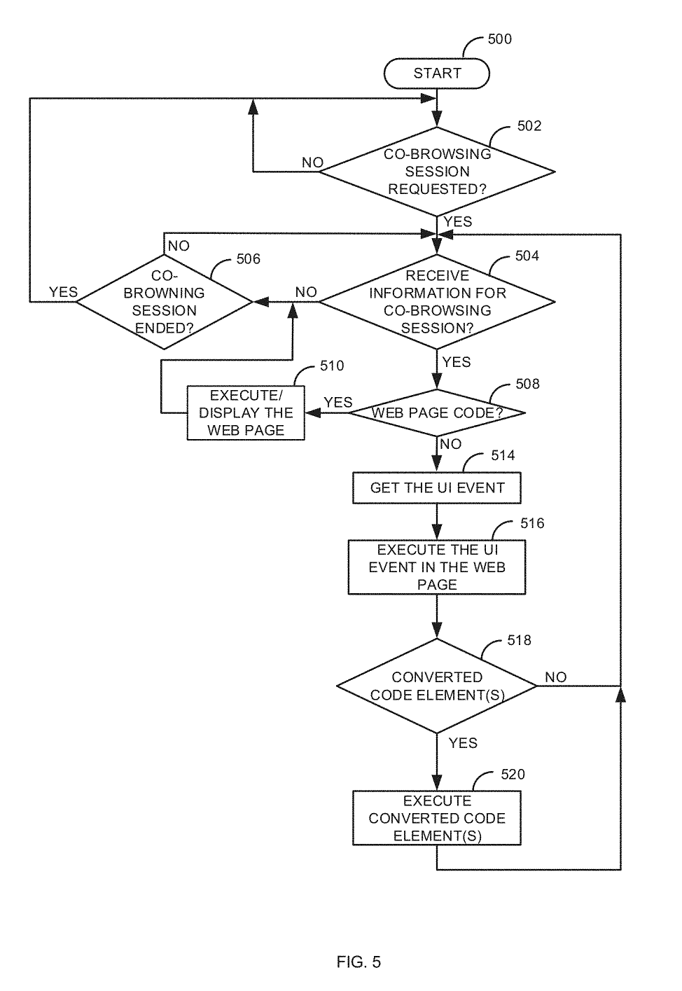

FIG. 5 is a flow diagram of a process of a browser 104N handling a co-browsing session. The process starts in step 500. The browser 104N determines, in step 502, if a co-browsing session has been requested. If a co-browsing session has not been requested in step 502, the process repeats step 502. Otherwise, if a co-browsing session has been requested in step 502, the browser 104N wait to receive information for the co-browsing session in step 504 (i.e., the information sent in steps 308 and 324 by the browser 104A that is forwarded by the co-browsing server 120 in step 408). If information has not been received from the co-browsing server 120, in step 504, the browser 104N determines if the co-browsing session has ended in step 506. If the co-browsing session has ended in step 506, the process goes back to step 502. Otherwise, if the co-browsing session has not ended in step 506, the process goes back to step 504.

If information is received from the co-browsing server 120 in step 504, the browser 104N determines, in step 508, if the information is the web page code 208 sent in step 308. If the information is the web page code 208 sent in step 308, the browser 104N executes the web page code 208 and displays the web page 131 in step 510. The process then goes to step 506.

Otherwise, if the information is not the web page code 208 in step 508, the browser 104N gets, in step 514, the identifier of the user interface event (sent in step 324) and executes the code associated with the user interface event (sent in step 308) in the web page 131 based on the identifier in step 516. For example, if the event was the user selecting a button, the code associated with the event is executed in step 516. The browser 104N determines in step 518 if there are any converted code element(s) (sent in step 324) that are associated with the event. If there are no converted code element(s) in step 518, the process goes back to step 504. Otherwise, if there are converted code element(s) in step 518, the browser 104N executes the converted code elements in step 520 and the process goes to step 504.

Examples of the processors (e.g., the microprocessor 102) as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A co-browsing server comprising:
a microprocessor; and
a computer readable medium, coupled with the microprocessor and comprising microprocessor readable and executable instructions that program the microprocessor to:
determine that the co-browsing server has established a co-browsing session between a first browser and a second browser;
receive, from the first browser, a first code element, wherein the first code element has been converted from a first programming language to a second programming language, wherein the first code element modifies a view of a web page in the first browser and wherein the modification of the view of the web page in the first browser is not identified by a user interface event in the web page;
receive, from the first browser, an identifier of the user interface event in the web page; and
send the first code element and the identifier of the user interface event to a second browser to provide a similar view of the first web page in the second browser.

2. The co-browsing server of claim 1, wherein the first code element comprises at least one of a Cascading Style Sheet (CSS) pseudo-element, a CSS pseudo class, a CSS class, a Hyper Text Markup Language (HTML) label element, and a HTML dropdown menu.

3. The co-browsing server of claim 1, wherein the first code element is converted from Hyper Text Markup Language (HTML) to Java Script code.

4. The co-browsing server of claim 1, wherein the first code element comprises a plurality of code elements and wherein the plurality of code elements are converted into the second programming language.

5. The co-browsing server of claim 1, wherein the first code element has been converted from the first programming language to the second programming language by getting a predefined code element to replace the first code element in the first programming language.

6. The co-browsing server of claim 1, wherein the co-browsing server supports a plurality of co-browsing sessions.

7. A method comprising:
determining, by a microprocessor, that a co-browsing session has been established, via a co-browsing server, between a first browser and a second browser;
receiving, by the microprocessor, from the first browser, a first code element, wherein the first code element has been converted from a first programming language to a second programming language, wherein the first code element modifies a view of a web page in the first browser, and wherein the modification of the view of the web page in the first browser is not identified by a user interface event in the web page;
receiving, by the microprocessor, from the first browser, an identifier of the user interface event in the web page; and
sending, by the microprocessor, the first code element and the identifier of the user interface event to a second browser to provide a similar view of the first web page in the second browser.

8. The method of claim 7, wherein the first code element comprises at least one of a Cascading Style Sheet (CSS) pseudo-element, a CSS pseudo class, a CSS class, a Hyper Text Markup Language (HTML) label element, and a HTML dropdown menu.

9. The method of claim 7, wherein the first code element is converted from Hyper Text Markup Language (HTML) to Java Script code.

10. The method of claim 7, wherein the co-browsing server supports a plurality of co-browsing sessions.

11. The method of claim 7, wherein the first code element comprises a plurality of code elements and wherein the plurality of code elements are converted into the second programming language.

12. A communication endpoint comprising:
a microprocessor; and
a computer readable medium, coupled with the microprocessor and comprising microprocessor readable and executable instructions that program the microprocessor to:
determine that a co-browsing session has been established between a first browser on the communication endpoint and a co-browsing server;
initiate a listener to identify a user interface event in a browsing session of a web page in the first browser;
identify a first code element associated with the user interface event, wherein the first code element modifies a view of the web page and wherein the modification of the view of the web page is not identified by the user interface event;
convert the first code element into a different programming language; and
send the converted first code element and an identifier of the user interface event to the co-browsing server.

13. The communication endpoint of claim 12, wherein the identified first code element is at least one of a Cascading Style Sheet (CSS) pseudo-element, a CSS pseudo class, a CSS class, a Hyper Text Markup Language (HTML) label element, and a HTML dropdown menu.

14. The communication endpoint of claim 12, wherein the listener listens for all user interface events for the web page and wherein the listener is in a Java Script run time engine.

15. The communication endpoint of claim 12, wherein the first code element is converted from Hyper Text Markup Language (HTML) into Java Script code.

16. The communication endpoint of claim 12, wherein the identifier of the user interface event is used by the second browser to execute code associated with the user interface event.

17. The communication endpoint of claim 12, wherein the first code element comprises a plurality of code elements and wherein the plurality of code elements are converted into the different programming language and sent to the co-browsing server.

18. The communication endpoint of claim 12, wherein the first code element comprises a plurality of code elements and wherein the plurality of code elements are converted into a plurality of different programming languages and sent to the co-browsing server.

19. The communication endpoint of claim 12, wherein converting the first code element into the different programming language comprises getting a predefined code element to replace the identified first code element.

20. The communication endpoint of claim 12, wherein the converted code element and the user interface event are sent at the same time.
